(19) United States
(12) Patent Application Publication
(10) Pub. No.: US 2008/0101482 A1
(43) Pub. Date: May 1, 2008

(54) Method and apparatus for refining MIMO channel estimation using the signal field of the data frame

(75) Inventors: Patrick Labbe, Hauts de Seine (FR); Marc Bernard De Courville, Paris (FR); Stephanie Rouquette-Leveil, Massy (FR)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/588,151

(22) Filed: Oct. 26, 2006

(51) Int. Cl. H04K 1/10

(52) U.S. Cl. 375/260

(57) ABSTRACT

A method is provided to compensate for environmental factors experienced by a wireless signal during transmission between a transmitter and a receiver. The method begins by receiving a wireless signal that includes a data frame having a preamble used to estimate a quantity (e.g., a channel transfer function) relating to signal quality. A portion of the preamble includes information specifying at least one parameter defining a format employed by the data frame. The selected portion of the preamble is decoded and a value for the quantity is estimated using the received preamble, including the decoded selected portion thereof. A signal is demodulated based at least in part on the estimated value of the quantity.

### FIELD OF THE INVENTION

The present invention relates generally to wireless transmission and reception techniques, and more particularly to a multiple-input, multiple-output transmission and reception system such as those being developed for use in IEEE 802.11 wireless LAN standards.

### BACKGROUND OF THE INVENTION

The IEEE 802.11 wireless LAN standardisation process recently created the “high throughput” task group, which aims to generate a new standard (i.e., 802.11n) for wireless LAN systems with a measured throughput of greater than 100 Mbit/s. The dominant technology that promises to be able to deliver these increased speeds are so-called MIMO (multiple-input, multiple-output) systems. MIMO systems are defined by having multiple antennas used for both transmission and reception. The maximum theoretical throughput of such a system scales linearly with the number of antennas, which is the reason that the technology is of great interest for high throughput applications. An example of such a system is shown in FIG. 1, with a portable computer 2 transmitting to an access point where each device has three antennas TX1-TX3.

These systems can offer improved throughput compared to single antenna systems because there is spatial diversity: each piece of information transmitted from each transmitting antenna travels a different path to each receiving antenna RX1-RX3, and as noted above, experiences distortion with different characteristics (different channel transfer functions). In the example of FIG. 1, there are three different channel transfer functions from each antenna to each receiver 3: the transfer function from transmitting antenna x to receiving antenna y is denoted by H_{xy}. Greater capacity is obtained by making use of the spatial diversity of these independent or semi-independent channels (perhaps in conjunction with other coding techniques) to improve the chance of successfully decoding the transmitted data. The examples given here use three transmitting antennas. However, any arbitrary number of transmit antennas can be used.

An important criterion of the high-throughput WLAN standardisation activity is that the new systems should interoperate with existing 802.11a and 802.11g OFDM WLAN systems. This means, primarily, that the legacy systems can interpret sufficient information from the transmission of the new system such that they do not interact in a negative manner (e.g., making sure that legacy systems remain silent during an ongoing transmission of the new system). For this reason, it has been proposed that the new high-throughput standard uses the same preamble structure as used for 802.11a/g. The preamble is the information transmitted before the data-carrying portion of a transmission, which allows the transmission to be detected and allows estimation of, amongst other things, the channel transfer function. The aim is that the transmitted preambles will be sufficiently similar so that legacy devices can determine the presence and duration of a high-throughput transmission.

So-called training symbols are used in the preamble of the transmission frames, which allow the receiver to estimate the channel transfer function. The receiver uses the estimated channel transfer function to decode the data signals while accounting for environmental effects. In going from SISO (single input, single output) systems to MIMO systems, additional training symbols are often required because of the additional channel transfer functions that are estimated. However, if the number of training symbols is increased, the data throughput will decrease, thereby reducing the performance of the MIMO system.

### BRIEF DESCRIPTION OF THE DRAWINGS

FIG. 1 shows a receiving and transmitting antenna arrangement employing multiple receive antennas and multiple transmit antennas.

FIG. 2 illustrates a conventional frame format in accordance with the IEEE 802.11a/g standards.

FIG. 3 shows the frame format employed in an illustrative example demonstrating the channel estimation process described herein.

FIG. 4 shows the results of simulations that were performed based on an estimate in the time domain to study the influence of the cyclic shift values on the final gain.

FIG. 5 illustrates a functional block diagram of a wireless receiver system that receives signals that employ the channel estimation techniques described herein

FIG. 6 illustrates a transmitter associated with a communication device that transmits packets or frames in accordance with the techniques described above.

FIG. 7 shows the results of simulations that were performed based on an estimate in the frequency domain to study the influence of the cyclic shift values on the final gain.

FIG. 8 is a flow diagram showing the channel estimation procedure as it may be performed by the transmitter depicted in FIG. 7.

### DETAILED DESCRIPTION

The channel estimation techniques described herein can be employed on a variety of different communication methods and devices utilizing a channel estimation procedure. One particular communication method is referred to as multicarrier modulation. One special case of multicarrier modulation is referred to as Orthogonal Frequency Division Multiplexing (OFDM). In general, OFDM is a block-oriented modulation scheme that maps a number of data constellation points onto a number of orthogonal carriers separated in frequency by BW/N, where BW is the bandwidth of the OFDM symbol and N is the number of tones in the OFDM symbol. OFDM is a technique by which data is transmitted at a high rate by modulating several low bit rate carriers in parallel rather than one single high bit rate carrier. OFDM is particularly useful in the context of Wireless Local Area Network (WLAN), Digital Video Broadcasting (DVB), High Definition Television (HDTV) as well as for Asymmetric Digital Subscriber Lines (ADSL) systems. OFDM can also be useful in satellite television systems, cable television, video-on-demand, interactive services, mobile communication devices, voice services and Internet services. For purposes of illustration, the channel estimation techniques will be described in the context of the IEEE 802.11 standards, (e.g., 802.11n) which employ OFDM. Of course, the techniques described herein are more generally applicable to any suitable MIMO or SISO wireless transmission techniques that employ multicarrier modulation.

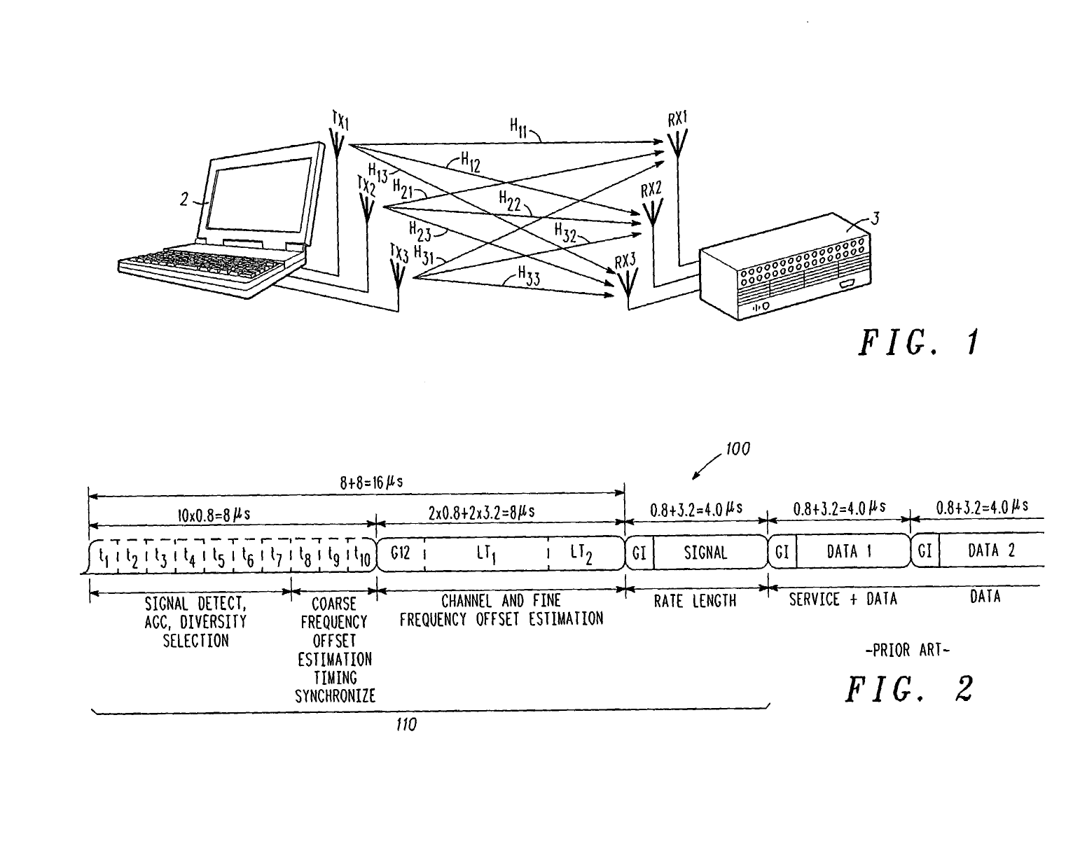

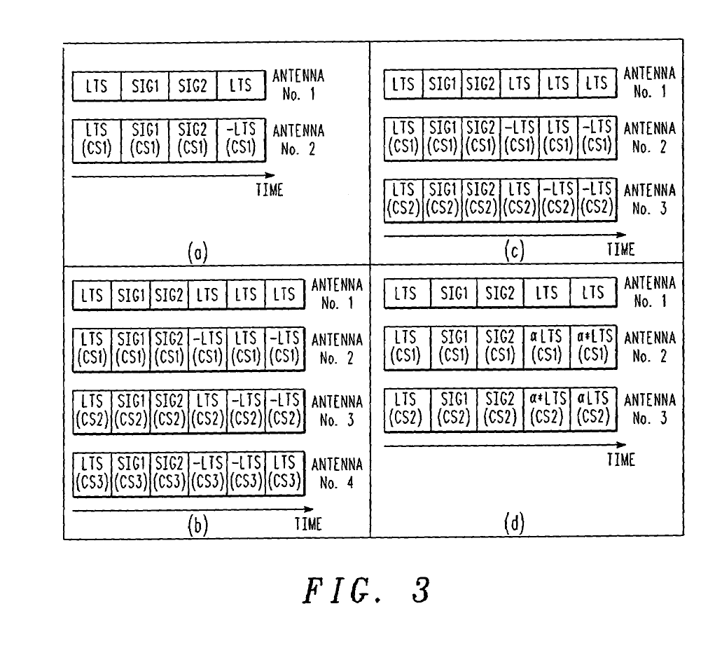

FIG. 2 illustrates a conventional frame format 100 in accordance with the IEEE 802.11a/g standards. As shown in FIG. 2, the frame format 100 comprises ten short training symbols, t1 to t10, collectively referred to as the Short Preamble. These are used to detect the presence of an incoming signal and to perform initial estimations of, for example, carrier frequency offset. Thereafter, there is a Long Preamble, consisting of a protective Guard Interval (GI2) and two Long Training Symbols, LT1 and LT2. These OFDM training symbols are used to perform channel estimation (i.e., an estimate of the channel transfer function from the transmitting antenna to each receiving antenna). Channel estimation is employed to determine the effects that the transmission environment has on the transmitted data signals. The channel estimation procedure utilizes the long training signals, which have a known magnitude and phase, to compensate for signal changes due to the transmission environment. The long training signals can be analyzed to determine the effects of the environment on the transmitted signal and this information utilized to adjust the data signals appropriately. One or more SIGNAL fields is contained in the first real OFDM symbol, and the information in the SIGNAL field or fields is needed to transmit general frame format parameters, such as packet length and data rate and the details of the modulation format that is used. The Short Preamble, Long Preamble and Signal field or fields comprise a legacy header 110. The OFDM symbols carrying the DATA follow the SIGNAL field.

One problem that arises in implementing a MIMO system involves estimation of the channel transfer function from each transmitting antenna to each receiving antenna. The transfer functions on each antenna can be separated in time and/or in frequency.

Probably the simplest way to generate channel estimates for each transmit antenna is to separate the transmissions in time with non overlapping Long Training Symbols. The initial preamble is transmitted on a single antenna. This will allow legacy devices to receive the preamble, and will allow MIMO devices to estimate the channel transfer function from the first transmitting antenna to each receiving antenna. Subsequently, long training symbols can be repeated on each of the other transmit antennas, allowing the channel transfer functions to be estimated from each of the remaining transmit antennas to each receive antenna. An alternative way to separate the transmissions is to apply Cyclic Shift Diversity (CSD) to the Long Training Symbols, which involves the addition of a delay to a sequence of Long Training Symbols from one antenna with respect to another antenna. The delays are less than the length of one OFDM symbol, but greater than the length of the channel transfer functions, thus allowing the channel transfer functions to be separated in time.

An alternative to separating the transmissions in time is to separate the transmissions on each antenna in frequency, for example, when a given antenna is the only one transmitting on a given subcarrier at a given time, or by using a specific preamble structure allowing the channel transfer functions to be separated in the frequency domain. For instance in IEEE802.11n draft specification an orthogonal structure has been specified to allow the separation in frequency domain of the channel transfer functions with little complexity and good performance.

The use of multiple long training symbols give an unambiguous and good-quality estimate for the channel transfer functions. However, they represent a significant overhead (e.g., an extra 20 microseconds per packet). Since the aim of the MIMO system is to provide increased throughput, this overhead becomes the limiting factor in determining the available transmission rate and the system may be less likely to meet the required target of 100 Mbps that has been established by the high throughput task group.

The performance of the MIMO estimation process is poor relative to a SISO estimation process because of the relatively short length of the long training symbols. Thus, the performance of the MIMO system is penalized by a lack of robustness of the channel estimator in order to achieve a very high throughput.

To overcome this limitation, channel estimation is performed not only with the Long Preamble, but also with the SIGNAL field. To use the SIGNAL field in this manner, the signal field symbols must be symbols that are known to the receiver. This can be accomplished by first decoding the SIGNAL field in the receiver before using the SIGNAL field symbol to refine the channel estimation. This process assumes that the SIGNAL field is decoded correctly. This is a reasonable assumption because if the SIGNAL field is incorrectly decoded the entire frame or packet will be lost anyway since the SIGNAL field describes the frame format. Thus, once decoded, the symbols in the SIGNAL field can act as known symbols in the same way that the Long Preamble is used as known symbols. In this way the number of observations used in the channel estimation process is increased and thus the accuracy of the channel estimation is increased.

The channel estimation process can be performed in the time or frequency domain.

The performance of the channel estimator using both the long training symbols and the symbols in the SIGNAL field of the preamble can be quantified in terms of its mean square error (MSE). Assuming that Y is the observation (i.e., the receiver vector), X is the OFDM vector to be transmitted by the transmitter (including LTS and SIG sequence over several time symbols), H is the MIMO channel matrix and N the noise, Y can be written as follows:

Y=XH+N

Then, the estimated channel in frequency domain using Zero-Forcing criterion is defined as:

Ĥ=X⁺Y=G_{f}Y for frequency domain estimation

Ĥ=(I [symbol] F)(X(I [symbol] F))⁺Y=GᵢY for time domain estimation

where + and \textcircled{×} symbols denote the pseudo inverse and Kronecker product operators respectively. I is the identity matrix and F the truncated Fourier matrix, whose rows correspond to the data and pilot tones, and whose columns correspond to the estimated taps. The error E on the channel estimates is defined as

E=Ĥ−H=GN

Finally the Mean Square Error (MSE) of the estimator is defined as:

MSE=σ²trace(GG^{H})

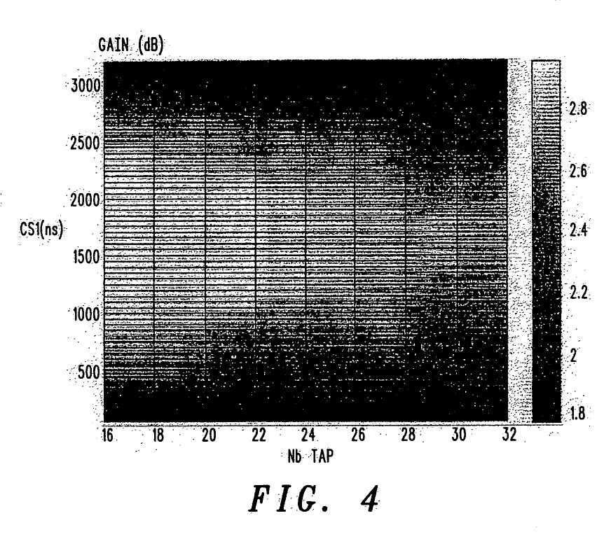

The results of the channel estimation process described above were determined in the frequency domain for MIMO systems employing two, three and four transmitters. FIG. 4 shows the frame formats that were employed in this example. Of course, other frame formats may be used as well. For purposes of generality two sequential signal fields are shown, as currently required by 802.11 high throughput draft specification. Of course, the same principles are applicable if any number of SIGNAL fields is employed. FIG. 4(a) shows a frame format for a two transmitter system in which orthogonality is achieved using a Walsh-Hadamard matrix. FIG. 4(b) shows a four transmitter system in which orthogonality is achieved using a Walsh-Hadamard matrix. FIGS. 4(c) and 4(d) show a frame format for a three transmitter system in which orthogonality is achieved by a truncated Walsh-Hadamard matrix and a Fourier Transform matrix, respectively. To maintain backward compatibility with legacy SISO receivers (e.g., 801.11a/g receivers), the fields of the frames transmitted by antennas two through four undergo a cyclic shift, which may be implemented as an advance or a delay. Legacy receivers can then receive the first Long Training Symbol and the two signaling symbols frame as a normal legacy preamble. In FIG. 4 the amount of the cyclic shift (CS) is denoted in each frame as a shift of CS1, CS2 or CS3 units.

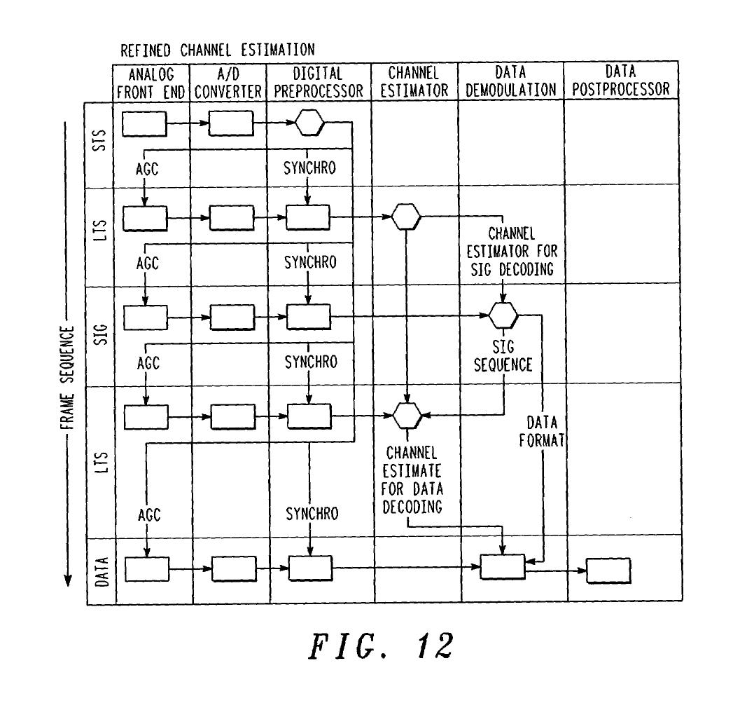

Simulations have been performed which show that in the frequency domain the gain that is achieved over the conventional approach depends only on the number of antennas that are employed and not on the particular CS values that are chosen. In particular, the maximum gain was achieved for the two transmitter system, which showed a gain of 1.76 dB. The gains achieved in the three and four transmitter systems were about 1 dB and 0.8 dB, respectively. These results are summarized in the tables shown in FIG. 8. FIG. 8(a) summarizes the results obtained in the two and four transmit antenna configurations. FIG. 8(b) summarizes the results obtained in the three transmit antenna configuration.

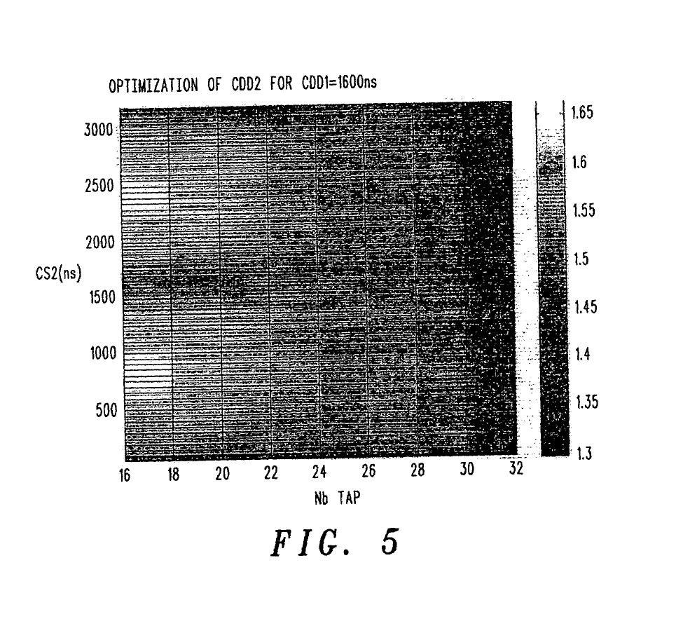

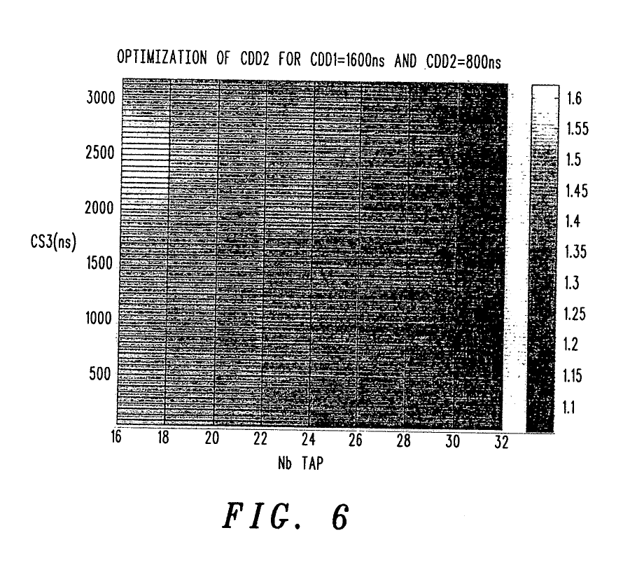

FIGS. 5 and 8 show the results of simulations that were performed to study the influence of the cyclic shift values on the final gain. FIG. 5 shows the results based on an estimate in the time domain and FIG. 8 shows the results based on an estimate in the frequency domain. A classical Zero Forcing algorithm over 52 data sub-carriers was used to perform the estimate in both the time and frequency domains. FIG. 5 shows the variations in gain with CS value and the number of taps for a sequential optimization of the cyclic shift values. FIGS. 5(a) and 5(b) show the optimization for CS1 and CS2, respectively, and FIGS. 5(c) and 5(d) both show the optimization for CS3. Several methods were used to select optimal CS values. When they are determined sequentially, the optimal values for antennas 2, 3 and 4 were found to be 800 ns, 1600 ns and 2400 ns or 800 ns, 2400 ns and 1600 ns. The gain that is achieved in this manner is higher than in the frequency domain. Specifically, the gain for a 2 transmitter configuration with CS1 equal to 1600 ns was as high as 2.96 dB, the gain for a three transmitter configuration with CS1 equal to 1600 ns and CS2 equal to 800 ns or 2400 ns was as high as 2.66 dB and the gain for a four transmitter configuration with CS1 equal to 1600 ns, CS2 equal to 800 ns and CS3 equal to 2400 ns (or CS2 equal to 2400 ns and CS3 equal to 800 ns) was as high as 1.62 dB.

FIG. 6 illustrates a functional block diagram of a wireless receiver system 10 that receives signals that employ the channel estimation techniques described herein. A data signal or burst is received by an antenna 14, which transfers the data signal to a front end processing component 12. The data signal or burst includes frames that include data as well as other information such as packet information, training information and calibration information. The front end processing component 12 amplifies the data signal, converts the data signal to an intermediate frequency (IF) and filters the data signal to eliminate signals that are outside of the desired frequency band. The front end processing component 12 feeds one or more analog-to-digital (A/D) converters 16 that sample the data signal and provide a digitized signal output. The front end processing component 12 can provide automatic gain control (AGC) to maintain the signal strength relative to the one or more A/D converters 16.

The digitized signal output from the A/D converter 16 is then provided to the digital preprocessor 18, which provides additional filtering of the digitized signals and decimates the samples of the digitized signal. The digital preprocessor 18 then performs a Fast Fourier Transform (FFT) on the digitized signal. The FFT on the digitized signal converts the signal from the time domain to the frequency domain so that the frequencies or tones carrying the data can be provided. The digital processor 18 can also adjust the gain of the LNA at the analog front end 12 based on the processed data, and include logic for detection of packets transmitted to the receiver 10. The exact implementation of the digital preprocessor 18 can vary depending on the particular receiver architecture being employed to provide the frequencies or tones carrying the data. The frequencies and tones can then be demodulated and/or decoded. However, the demodulation of the tones requires information relating to the wireless channel magnitude and phase at each tone. The effects of the dispersion caused by the channel need to be compensated prior to decoding of the signal, so that decoding errors can be minimized. This is achieved by performing channel estimation in the manner described above. Accordingly, the digital preprocessor 18 provides the frequencies or tones to a channel estimator 20.

The channel estimator 20 determines a channel estimate employing training tones embedded in the long training symbols and the SIGNAL field symbols. The SIGNAL field symbols, which may be decoded downstream in the data modulator 22 (or in any other appropriate component), are treated as known symbols that can serve as additional training symbols used in the channel estimation process. The channel estimator 20 employs the long training symbols and/or training tones to perform channel estimation. Since the training tones, including the decoded SIGNAL field symbols, have a known magnitude and phase, the channel response at the training tones is readily determined. For example, the known channel response at the training tones can then be interpolated in the frequency domain to determine the channel response at the data tones. A cyclic interpolation procedure, for example, can be employed.

The channel estimate is provided to a data demodulator 22 for demodulation of the digital data signal, which then transfers the demodulated data signal to data postprocessing component 26 for further signal processing. The data postprocessing component 26 decodes the demodulated data signal and performs forward error correction (FEC) utilizing the information provided by the data demodulator in addition to providing block or packet formatting. The data postprocessing component 26 then outputs the data.

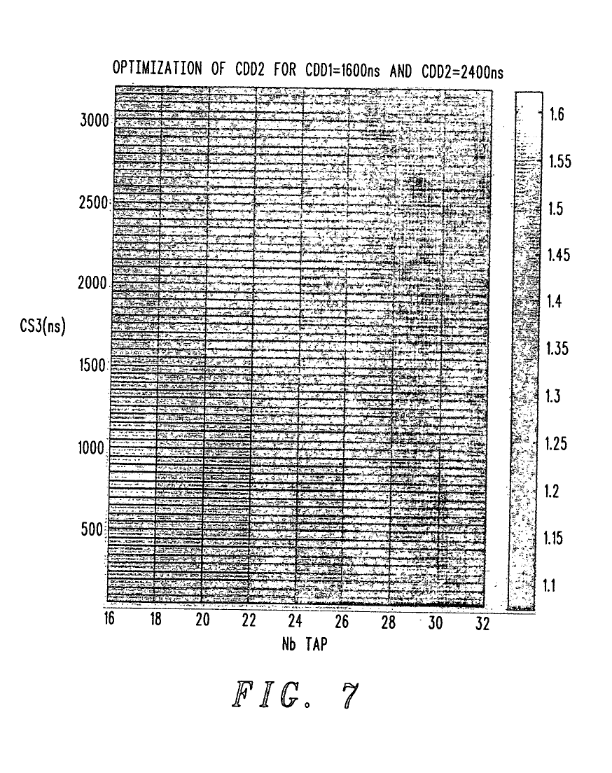

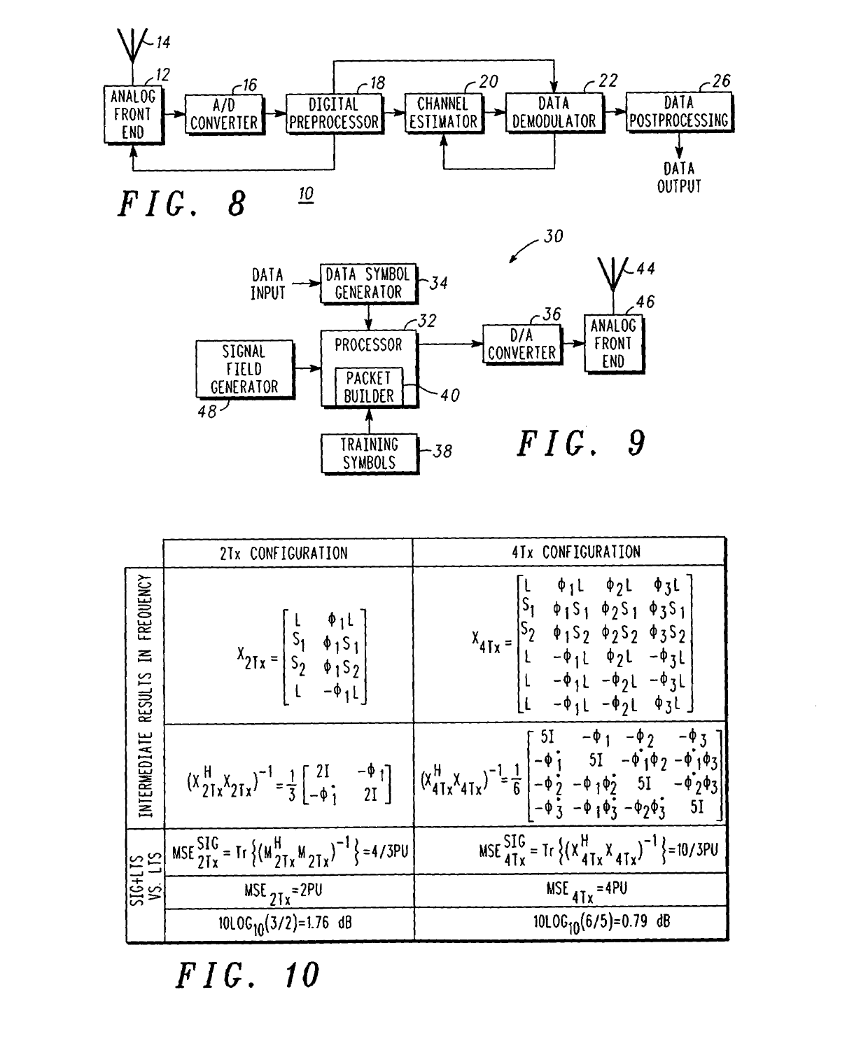

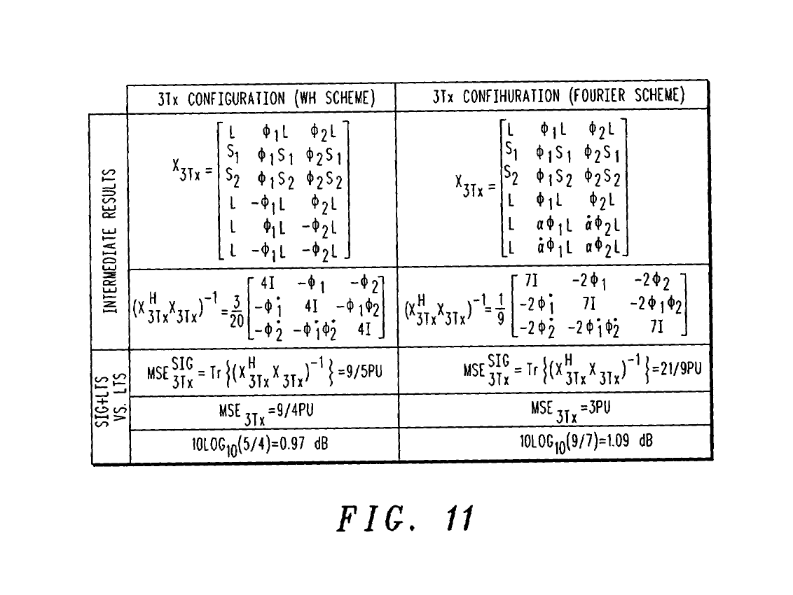

FIG. 7 illustrates a transmitter 30 associated with a communication device that transmits packets or frames in accordance with the techniques described above. The transmitter 30 includes a processor 32 with a packet builder component 40. The packet builder component 40 builds data packets for transmission to one or more receivers in a wireless communication system. The data packets can be data packets that conform to one or more wireless communication standards such as IEEE 802.11a/g/n. The system 30 includes a SIGNAL field generator 48 that provides the packet builder 40 with a SIGNAL field symbol or symbols. The system 30 also includes a data symbol generator 48 that receives a data input and builds data symbols to be provided to the packet builder 40. Additionally, the packet builder 40 employs a plurality of training symbols 38 to be embedded in the transmission packets. The packet builder 40 provides training symbols in the data packet based on the communication format of the data packet.

The packet builder 40 combines the training symbols with the symbols from the header symbol generator 48 and the data symbol generator 34 to build the desired packet. If the built packet is represented in the frequency domain, the processor 32 performs an IFFT (Inverse Fast Fourier Transform) to convert it into a time domain representation. Once the built packet is represented in the time domain, the processor 32 provides the built packet to a D/A converter 36. The D/A converter 36 converts the digital data to the analog domain for transmission by an analog front end 46. The analog front end 46 includes upmixers, filters and one or more power amplifiers coupled to an antenna 44 for wireless transmission to one or more receivers.

FIG. 9 is a flow diagram showing the channel estimation procedure as it may be performed by the transmitter depicted in FIG. 7. Time increases along the vertical access, beginning at the time a frame is received. The horizontal axis lists the components of the transmitter described above. Each component performs its respective process over the time period that is transpiring during the boxes corresponding to each component and which are located in the rows and columns of the diagram.

As shown in FIG. 9, each field of the preambles is treated sequentially. For instance, the process begins when the short training symbol (STS) preamble is received by the analog front-end. The STS preamble is transformed by the A/D converter so that the digital preprocessor can extract the information needed to adjust the automatic gain control (AGC) and to synchronize the receiver. Next, the first long training symbol (LTS) preamble is received by the analog front end, transformed by the A/D converter, and preprocessed by the digital preprocessor so that channel estimation can be performed by the channel estimator. The output from the channel estimator at this step will be subsequently used in the data demodulation of the SIG field. Likewise, the second LTS preamble is then received by the analog front end, transformed by the A/D converter, and preprocessed by the digital preprocessor so that channel estimation can be performed by the channel estimator using both the output from the channel estimation of the first LTS preamble and the SIG preamble. At this point the channel estimate outputs a resulting channel estimate. Finally, the data preamble is then received by the analog front end, transformed by the A/D converter, and preprocessed by the digital preprocessor. The data is then demodulated using the resulting channel estimate as well as the format information derived from demodulation of the SIG preamble. The data may undergo post-processing in accordance with well-known techniques.

1. A method to compensate for environmental factors experienced by a wireless signal during transmission between a transmitter and a receiver, comprising:
receiving a wireless signal that includes a data frame having a preamble used to estimate a quantity relating to signal quality, wherein a portion of the preamble includes information specifying at least one parameter defining a format employed by the data frame;
decoding the selected portion of the preamble;
estimating a value for the quantity using the received preamble including the decoded selected portion thereof; and
demodulating a signal based at least in part on the estimated value of the quantity.

2. The method of claim 1 wherein the quantity relating to signal quality is a channel transfer function.

3. The method of claim 1 wherein the selected portion of the preamble comprises symbols located in a SIGNAL field of the data frame.

4. The method of claim 1 wherein the selected preamble portion includes training symbols.

5. The method of claim 1 wherein the data frame is compatible with IEEE 802.11 a/g standards.

6. The method of claim 1 wherein the wireless symbols employs a multicarrier modulation scheme.

7. The method of claim 6 wherein the multicarrier modulation scheme is Orthogonal Frequency Division Multiplexing (OFDM).

8. A wireless receiver system, comprising:
an antenna arrangement for receiving a wireless signal that includes a data frame having a preamble used to estimate a quantity relating to signal quality, wherein a selected portion of the preamble includes information specifying at least one parameter defining a format employed by the data frame;
an A/D converter for converting the wireless signal into a digitized signal;
a data demodulator for demodulating data embodied in the digitized signal and for decoding the selected portion of the preamble;
a channel estimator for estimating a quantity relating to signal quality that is used by the data demodulator to demodulate the data, wherein the channel estimator is configured to estimate the value for the quantity using the received preamble including the decoded selected portion of the preamble.

9. The wireless receiver system of claim 8 wherein the quantity relating to signal quality is a channel transfer function.

10. The wireless receiver system of claim 8 wherein the selected portion of the preamble comprises symbols located in a SIGNAL field of the data frame.

11. The wireless receiver system of claim 8 wherein the selected preamble portion includes training symbols.

12. The wireless receiver system of claim 8 wherein the data frame is compatible with IEEE 802.11 a/g standards.

13. The wireless receiver system of claim 8 wherein the wireless symbols employs a multicarrier modulation scheme.

14. The wireless receiver system of claim 13 wherein the multicarrier modulation scheme is Orthogonal Frequency Division Multiplexing (OFDM).

15. The wireless receiver system of claim 8 wherein the antenna arrangement includes a single antenna.

16. The wireless receiver system of claim 8 wherein the antenna arrangement includes having multiple antennas.

17. At least one computer-readable medium encoded with instructions which, when executed by a processor, performs a method including:
receiving a wireless signal that includes a data frame having a preamble used to estimate a quantity relating to signal quality, wherein a portion of the preamble includes information specifying at least one parameter defining a format employed by the data frame;
decoding the selected portion of the preamble;
estimating a value for the quantity using the received preamble including the decoded selected portion thereof; and
demodulating a signal based at least in part on the estimated value of the quantity.

18. The computer-readable medium of claim 17 wherein the quantity relating to signal quality is a channel transfer function.

19. The computer-readable medium of claim 17 wherein the selected portion of the preamble comprises symbols located in a SIGNAL field of the data frame.

20. The computer-readable medium of claim 17 wherein the selected preamble portion includes training symbols.
